(19) United States
(12) Patent Application Publication
(10) Pub. No.: US 2024/0269792 A1
(43) Pub. Date: Aug. 15, 2024

(54) Cutting Machining Apparatus

(71) Applicant: NISSIN MANUFACTURING CO., LTD., Kyoto (JP)

(72) Inventors: Kenji Inoue, Kyoto (JP); Chiori Mochizuki, Kyoto (JP); Hidekazu Tsuji, Kyoto (JP); Koji Tanaka, Kyoto (JP)

(21) Appl. No.: 18/335,279

(22) Filed: Jun. 15, 2023

(30) Foreign Application Priority Data
Jun. 15, 2022 (JP) 2022-096872

(51) Int. Cl. B23Q 17/09; B23Q 15/22

(52) U.S. Cl. CPC B23Q 17/0957; B23Q 15/22

(57) ABSTRACT

A cutting machining apparatus 1 includes: a head 5 including a spindle drive 51 that rotary drives a rotary spindle with a tool 20 secured to a tip of the rotary spindle; a proximity sensor 34; a signal acquirer obtaining a signal waveform of a detection signal that is output from the proximity sensor 34 when the rotary spindle 52 is rotated in a state in which the head 5 is moved so that the proximity sensor 34 faces a lateral side of the tool before and after cutting machining of the workpiece W using the tool; and a determiner determining whether or not the tool 20 is broken based on whether or not there is a difference in signal waveforms obtained before and after the cutting machining.

### FIELD OF THE INVENTION

The present disclosure relates to a cutting machining apparatus.

### BACKGROUND OF THE INVENTION

A gun drill formed by joining a cutting edge, a steel pipe, and a handle to each other by a silver soldering joint has been proposed, wherein one end of an enamel wire is connected to a copper plate that is provided at an end of the handle and the other end is connected, with a conductive adhesive, near a proximal end of the cutting edge, the enamel wire is buried in an electrically isolated state on the surface of the cutting edge, the steel pipe, and the handle (for example, refer to Japanese Patent Application Publication No. H09-225719). When the gun drill is broken at the silver soldering joint during use, the enamel wire is cut at the same time, and the conductivity of the enamel wire is blocked. Thus, the breakage of the gun drill can be detected by monitoring the conductivity state of the enamel wire.

However, in the case of the gun drill described in Japanese Patent Application Publication No. H09-225719, for example, when the tip of the cutting edge where the enamel wire is not embedded is broken, the breakage of the cutting edge cannot be detected. In such a case, the workpiece continues to be processed despite the tip of the cutting edge being damaged, and the machining accuracy of the workpiece may be greatly reduced.

The present disclosure was made in consideration of the above problem. Thus, an objective of the present disclosure is to provide a cutting machining apparatus that can improve machining accuracy of a workpiece by quickly detecting a breakage of a tool.

### SUMMARY OF THE INVENTION

In order to achieve the above objective, the cutting machining apparatus according to the present disclosure includes:
a head including a spindle drive that rotary drives a rotary spindle with a tool secured to a tip of the rotary spindle;
a first proximity sensor;
a signal acquirer obtaining detection signal information indicating an intensity of a detection signal that is output from the first proximity sensor when the rotary spindle is rotated in a state in which the head is moved so that the first proximity sensor faces a lateral side of the tool before and after cutting machining of a workpiece using the tool; and
a determiner that determines whether or not the tool is broken based on whether or not there is a difference in signal waveforms corresponding to time transitions in intensities of detection signals indicated by detection signal information obtained before and after the cutting machining.

According to the present disclosure, the signal acquirer obtains detection signal information indicating an intensity of a detection signal that is output from the proximity sensor when the rotary spindle is rotated in a state in which the head is moved so that the proximity sensor is disposed on the lateral side of the tool before and after cutting machining of a workpiece. The determiner then determines whether or not the tool is broken based on whether or not there is a difference in signal waveforms corresponding to time transitions in intensities of detection signals indicated by detection signal information obtained before and after the cutting machining. As a result, a breakage of the tip of the tool during cutting machining can be detected quickly, and thus the machining accuracy of the workpiece can be improved.

### BRIEF DESCRIPTION OF DRAWINGS

A more complete understanding of this application can be obtained when the following detailed description is considered in conjunction with the following drawings, in which:

FIG. 1 is a schematic diagram of a cutting machining apparatus according to an embodiment of the present disclosure;

FIG. 2 is a partially broken side view of the cutting machining apparatus according to the embodiment;

FIG. 3A is a perspective view of a head according to the embodiment:

FIG. 3B is a diagram illustrating a head viewed from the +Z direction side according to the embodiment;

FIG. 4 is a side view of a holding unit according to the embodiment:

FIG. 5 is a block diagram illustrating the configuration of a controller according to the embodiment:

FIG. 6A is a diagram illustrating a state in which the head is arranged on a lateral side of a proximity sensor provided in a holding unit according to the embodiment:

FIG. 6B is a diagram illustrating a state in which the head is arranged on a lateral side of a workpiece according to the embodiment;

FIG. 7 is a flowchart illustrating an example of a flow of the cutting machining processing performed by the cutting machining apparatus according to the embodiment;

FIG. 8A is a diagram illustrating an example of a signal waveform before cutting machining obtained by a signal acquirer according to the embodiment;

FIG. 8B is a diagram illustrating an example of a signal waveform after cutting machining when a tool is partially broken obtained by the signal acquirer according to the embodiment;

FIG. 9 is a flowchart illustrating an example of a flow of cutting machining processing performed by the cutting machining apparatus according to the embodiment; and

FIG. 10 is a cross-sectional view illustrating a portion of a holding unit according to a variation.

### DETAILED DESCRIPTION OF THE INVENTION

Hereinafter, a cutting machining apparatus according to an embodiment of the present disclosure is described with reference to the drawings. The cutting machining apparatus according to the present embodiment includes: a head including a spindle drive that rotary drives a rotary spindle with a tool secured to the tip of the rotary spindle; a proximity sensor; a signal acquirer obtaining detection signal information indicating an intensity of a detection signal that is output from the proximity sensor when the rotary spindle is rotated in a state in which the head is moved so that the proximity sensor faces a lateral side of the tool before and after cutting machining of a workpiece using the tool; and a determiner determining whether or not the tool is broken based on whether or not there is a difference in signal waveforms corresponding to time transitions of intensities of detection signals indicated by detection signal information obtained before and after cutting machining. The cutting machining apparatus according to the present embodiment is particularly used in a medical field where high precision machining of a workpiece is required while maintaining a clean environment of a machining area where machining of the workpiece is conducted. The cutting machining apparatus is used, for example, to create a so-called bone thread for joining a fractured bone of a patient from a bone fragment collected from the patient, or to create a filling member having a shape adapted to the shape of a defective portion to fill the defective portion of the patient's bone. Note that the cutting machining apparatus according to the present embodiment is not limited to those machining the aforementioned bone fragments, and may be applied for processing other living tissues or materials that are different from living tissues.

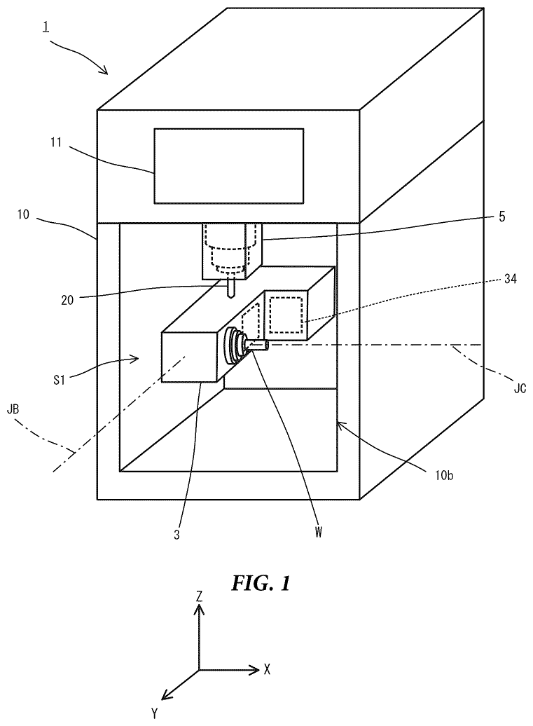

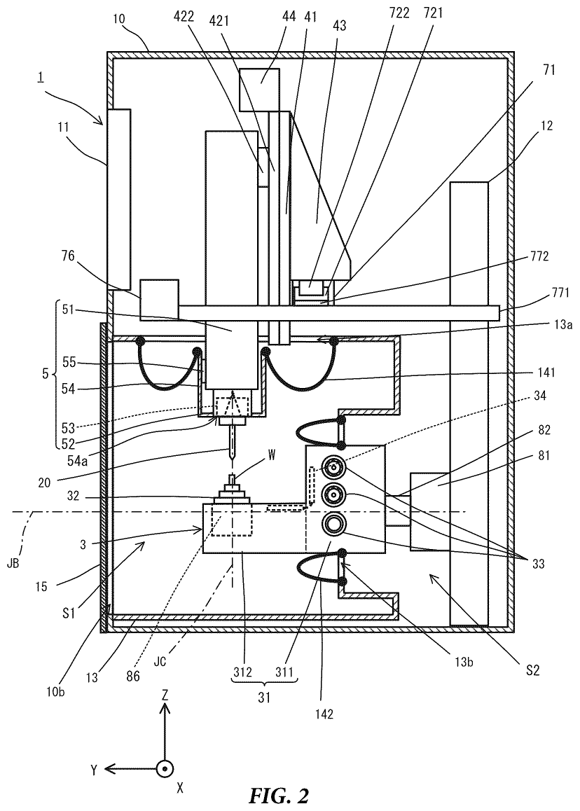

As illustrated in FIG. 1, a cutting machining apparatus 1 according to the present embodiment includes: a holding unit 3 that holds a workpiece W; a head 5 that is positioned facing the holding unit 3 and holds a tool 20; a controller (not illustrated) that controls the operation of the holding unit 3 and the head 5; and a display panel 11. In addition, the cutting machining apparatus 1 includes a chassis 10 of a rectangular box shape that has an opening 10b in the +Y direction-side side wall formed for inserting and removing a workpiece W and housing the holding unit 3, the head 5, and the controller inside. Although not illustrated in FIG. 1, the opening 10b can be occluded by a door 15 described later. Furthermore, as illustrated in FIG. 2, the cutting machining apparatus 1 includes: an interior case 13 of a rectangular box shape one side of which is open and in which portions of the holding unit 3 and the head 5 are disposed; a first cover 141 and a second cover 142 formed of a soft material; and a door 15 covering the opening 10b from the +Y direction side. The cutting machining apparatus 1 also includes a lift drive 44 that raises and lowers the head 5 in a vertical direction, an X-direction drive 71 that drives the head 5 along the X-axis direction, and a Y-direction drive 76 that drives the head 5 along the Y-axis direction. The chassis 10 has the interior case 13 disposed inside and the display panel 11 mounted on the +Z direction side of the opening 10b in the +Y direction-side side wall. The display panel 11 displays, for example, a progress status of cutting machining processing performed on a workpiece W.

The interior case 13 has a machining area S1 formed inside where machining of a workpiece W is conducted. The machining area S1 is enclosed by the interior case 13 and the door 15. The interior case 13 is disposed inside the chassis 10 in a posture in which the open portion of the interior case 13 is oriented toward the opening 10b side of the chassis 10 and has openings 13a and 13b provided in the +Z direction-side peripheral wall and the −Y direction-side peripheral wall, respectively. Here, the opening 13a is a first opening through which the head 5 is inserted, and the opening 13b is a second opening through which the holding unit 3 is inserted. In addition, a support member 12 that supports the head 5, the holding unit 3, and the like is disposed in an area S2 outside the interior case 13 within the chassis 10.

The head 5 includes: a long rotary spindle 52 provided, at one end of the longitudinal direction, with a chuck 53 that holds the tool 20; a spindle drive 51 that rotates the rotary spindle 52 about a central axis along the longitudinal direction thereof; a head cover 54; and a proximity sensor 55. The chuck 53 includes a chuck (not illustrated) and an actuator (not illustrated) that drives the chuck, and the chuck opens and closes according to a control signal that is input from the controller. The head 5 is secured to a slider 422 that is slidably held on a rail 421 extending along the Z axis direction on the +Y direction side of a base 41. The lift drive 44 includes: a long feed screw (not illustrated) arranged along the Z-axis direction and screwed to a nut (not illustrated) provided on a portion of the slider 422; and a motor (not illustrated) coupled to the feed screw to rotate the feed screw. The lift drive 44 then raises and lowers the slider 422 and the head 5 secured to the slider 422 along the Z-axis direction by rotating the feed screw arranged along the Z-axis direction.

The base 41 is also secured via a bracket 43 to a slider 722 that is slidably held on a rail 721 extending along the X-axis direction. The X-direction drive 71 includes: a long feed screw (not illustrated) arranged along the X-axis direction and screwed to a nut (not illustrated) provided on a portion of the bracket 43; and a motor (not illustrated) coupled to the feed screw to rotate the feed screw. The X-direction drive 71 then moves the slider 722 and the base 41 secured to the slider 722 along the X-axis direction by rotating the feed screw arranged along the X-axis direction. As a result, the X-direction drive 71 moves the base 41 and the head 5 together along the X-axis direction via the feed screw. The rail 721 is supported by sliders 772 that are slidably held on two rails 771 of which longitudinal ends extend along the Y-axis direction. The Y-direction drive 76 includes: a long feed screw (not illustrated) arranged along the Y-axis direction and screwed to a nut (not illustrated) provided on a portion of the base 41; and a motor (not illustrated) coupled to the feed screw to rotate the feed screw. The Y-direction drive 76 then moves the sliders 772 and the rail 721 supported by the sliders 772 along the Y-axis direction by rotating the feed screw arranged along the Y-axis direction. As a result, the Y-direction drive 76 moves the rail 721, the slider 722, the base 41, and the head 5 together via the feed screw along the Y-axis direction.

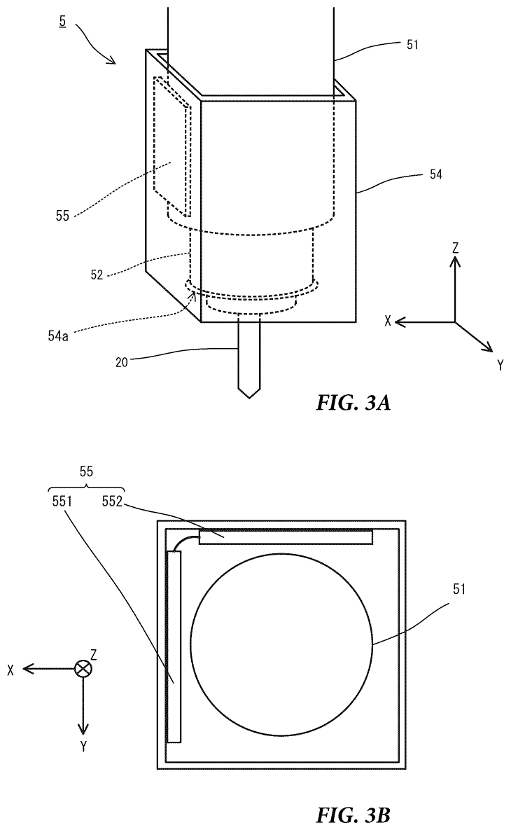

As illustrated in FIG. 3A, the head cover 54 has a bottomed square tube shape with a bottom wall provided with an opening 54a through which the tool 20 is inserted and has the tip of the spindle drive 51 and the rotary spindle 52 disposed inside. The proximity sensor 55 is, for example, an inductive proximity sensor that is a second proximity sensor including a sensor part 551 and a signal output part 552, as illustrated in FIG. 3B. The sensor part 551 has an induction coil (not illustrated) and a flat rectangular plate-shaped package in which the induction coil is buried. The signal output part 552 has a flat rectangular plate-shaped package that internally includes: an oscillation circuit (not illustrated) connected to the induction coil; an amplitude detection circuit (not illustrated) that detects the amplitude of an output current of the oscillation circuit and outputs a detection voltage reflecting the intensity of the detected amplitude; and an output circuit (not illustrated) that generates a detection signal based on the detection voltage output from the amplitude detection circuit and transmits the detection signal to the controller. The sensor part 551 and the signal output part 552 are disposed in an area between the head cover 54 and the spindle drive 51 inside the head cover 54.

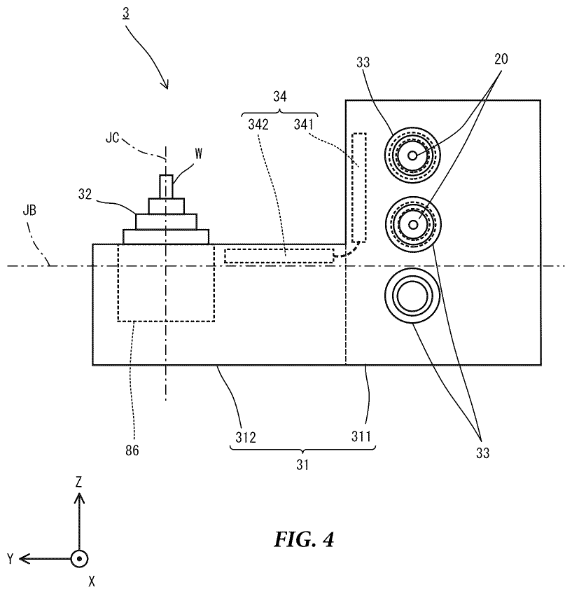

As illustrated in FIG. 4, the holding unit 3 includes: a workpiece holder 32 that holds a workpiece W; a tool holder 33 that has a substantially bottomed circular shape and holds the tool 20 in a state in which the tool 20 is inserted inside; a box-shaped unit body 31; and a proximity sensor 34. Also, as illustrated in FIG. 2, the holding unit 3 includes: a rotary drive 81 that causes the entire unit body 31 to rotate about a rotational axis (hereinafter, referred to as “B axis”) JB extending along the longitudinal direction of the unit body 31; and a rotary drive 86 that causes the workpiece holder 32 to rotate about a rotational axis (hereinafter, referred to as the “C axis”) JC extending along a direction orthogonal to the longitudinal direction of the unit body 31.

The rotary drive 86 includes a motor that is disposed inside the unit body 31 and rotates a shaft (not illustrated) that extends along the C axis JC and of which tip is coupled to the workpiece holder 32. The rotary drive 81 includes a motor that supports the −Y direction-side end of a shaft 82 that has a tubular shape and extends along the B axis to rotate the shaft 82 about the B axis JB. The unit body 31 is secured to the +Y direction-side end of the shaft 82. The rotary drive 81 is supported by the support member 12 provided on the outside of the interior case 13 within the housing 10.

The unit body 31 has a hollow rectangular first section 311 and a rectangular box-shaped second section 312 that is continuous to the first section 311 at the +Y direction-side end of the first section 311. The first section 311 is secured to the shaft 82 at the −Y direction side end of the first section 311, as illustrated in FIG. 2. Then, when the shaft 82 of the rotary drive 81 rotates about the B axis JB, the unit body 31 rotates about the B axis JB accordingly. The workpiece holder 32 is a chuck that grips the proximal end of a long workpiece W. The workpiece holder 32 is secured to the peripheral wall of the second section 312 of the unit body 31. The tool holder 33 is secured to the unit body 31 in such a way that, in a state in which the tool 20 is not inserted in the tool holder 33, the inside of the tool holder 33 is in communication with the outside of the unit body 31 and the outer wall of the tool holder 33 is isolated from the outside of the unit body 31.

The proximity sensor 34 is, for example, an inductive proximity sensor that is a first proximity sensor including a sensor part 341 and a signal output part 342. The sensor part 341 has an induction coil (not illustrated) and a flat rectangular plate-shaped package in which the induction coil is buried. The signal output part 342 has a flat rectangular plate-shaped package that internally includes: an oscillation circuit (not illustrated) connected to the induction coil; an amplitude detection circuit (not illustrated) that detects the amplitude of an output current of the oscillation circuit and outputs a detection voltage reflecting the intensity of the detected amplitude; and an output circuit (not illustrated) that generates a detection signal based on the detection voltage output from the amplitude detection circuit and transmits the detection signal to the controller. The sensor part 341 is disposed inside the side wall of the first section 311 of the unit body 31, facing the workpiece holder 32 in the Y-axis direction, and the signal output part 342 is disposed adjacent to the workpiece holder 32 inside the second section 312 of the unit body 31.

The first cover 141 is formed of a soft material such as a thin rubber film, a vinyl film, or the like, and is preferably sterilized using, for example, ethylene oxide gas. The first cover 141 has a tube shape having a shape in which one end in the tube axial direction is reduced in diameter toward the other end, the entire one end in the tube axial direction is secured to the outer periphery of the opening 13a of the interior case 13, and the other entire end in the tube axial direction is secured to the entire end opposite to the bottom wall side of the head cover 54. The second cover 142 is also formed of a soft material such as a thin rubber film, a vinyl film, or the like, and is preferably sterilized using, for example, ethylene oxide gas. The second cover 142 has a tube shape having a shape in which one end in the tube axial direction is reduced in diameter toward the other end, the entire one end in the tube axial direction is secured to the outer periphery of the opening 13b of the interior case 13, and the other entire end in the tube axial direction is secured to the unit body 31 of the holding unit 3.

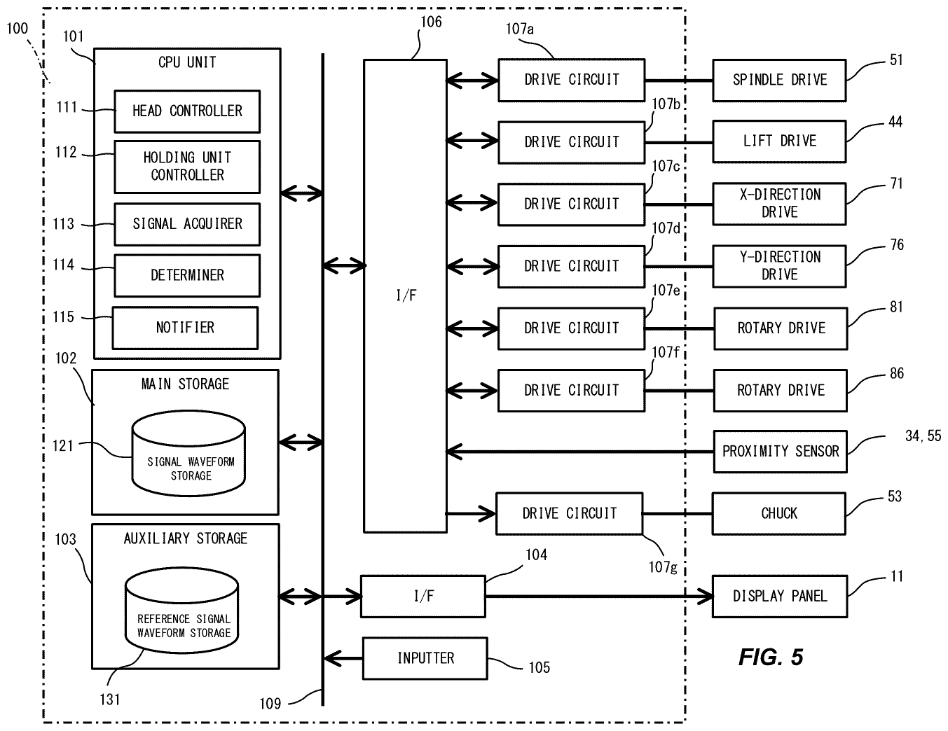

The controller includes: for example, a programmable logic controller (PLC) including a central processing unit (CPU) unit and an input/output control unit; and an input device, such as a keyboard and a touch panel, connected to the PLC. As illustrated in FIG. 5, the controller 100 has a CPU unit 101, a main storage 102, an auxiliary storage 103, an inputter 105, interfaces 106, 104, and a bus 109 that connects the units with each other. The controller 100 also includes drive circuits 107a, 107b, 107c, 107d, 107e, 107f, and 107g. The main storage 102 is a volatile memory such as, for example, a random access memory (RAM) and is used as a working area of the CPU unit 101. The auxiliary storage 103 is a non-volatile memory, such as a semiconductor memory, and stores a program for realizing various functions of the controller 100 including a machining program. The inputter 105 includes the aforementioned input device and an interface for connecting the input device to the bus 109. When the inputter 105 receives various operation information that is input by a user operating the input device, the inputter 105 outputs the received various operation information to the CPU unit 101. The interface 106 is connected to the drive circuits 107a, 107b, 107c, 107d, 107e, 107f, and 107g and converts control information input from the CPU unit 101 into a control signal to output to the drive circuits 107a, 107b, 107c, 107d, 107e, 107f, and 107g. The interface 106 is also connected to the proximity sensors 34, 55 to convert the detection signal input from the proximity sensors 34, 55 into detection signal information and output the detection signal information to the CPU unit 101. The interface 104 outputs notification information that is input from the CPU unit 101 to the display panel 11 to notify a user of whether or not the tool 20 is broken.

The drive circuit 107a drives the spindle drive 51 based on a control signal that is input via the interface 106. The drive circuit 107b drives the lift drive 44 based on a control signal that is input via the interface 106. The drive circuit 107c drives the X-direction drive 71 based on a control signal that is input via the interface 106, and the drive circuit 107d drives the Y-direction drive 76 based on a control signal input via the interface 106. The drive circuit 107e drives the rotary drive 81 based on a control signal that is input via the interface 106, and the drive circuit 107f drives the rotary drive 86 based on a control signal that is input via the interface 106. The drive circuit 107g drives the chuck 53 based on a control signal that is input via the interface 106.

The CPU unit 101 functions as a head controller 111, a holding unit controller 112, a signal acquirer 113, a determiner 114, and a notifier 115 by reading the aforementioned program stored in the auxiliary storage 103 into the main storage 102 and executing the program. The auxiliary storage 103 also includes a reference signal waveform storage 131 that stores signal waveform information that is obtained by the proximity sensor 34 and reflects the shape of the tool 20 before cutting machining of the workpiece W serving as a reference for determining whether or not the tool 20 is broken. The main storage 102 temporarily stores signal waveform information indicating the waveform of a detection signal of the proximity sensor 34 with regard to the tool 20 after cutting machining of the workpiece W and signal waveform information indicating the waveform of a detection signal of the proximity sensor 55 with regard to the workpiece W. The reference signal waveform storage 131 stores signal waveform information indicating the signal waveform of a detection signal that is output from the proximity sensor 34 when the rotary spindle 52 is rotated in a state in which the head 5 is moved so that the proximity sensor 34 provided in the holding unit 3 faces a lateral side of the tool 20 before cutting machining of the workpiece W, in association with the tool identification information that identifies the tool 20.

The signal waveform storage 121 temporarily stores signal waveform information indicating the waveform of a detection signal that is output from the proximity sensor 34 when the rotary spindle 52 is rotated in a state in which the head 5 is moved so that the proximity sensor 34 provided in the holding unit 3 faces the lateral side of the tool 20 after cutting machining of the workpiece W. The signal waveform storage 121 further temporarily stores signal waveform information indicating the waveform of a detection signal that is output from the proximity sensor 55 when the workpiece holder 32 is rotated in a state in which the head 5 is moved so that the proximity sensor 55 provided in the head 5 faces the lateral side of the workpiece W after cutting machining of the workpiece W.

The head controller 111 generates control information for rotating the rotary spindle 52 or maintaining the rotary spindle 52 in a non-rotating state in accordance with the method of cutting machining the workpiece W, and outputs the control information to the interface 106. At this time, the drive circuit 107a operates or stops the spindle drive 51 based on the control signal input from the interface 106. The head controller 111 also generates control information for raising and lowering the head 5 in accordance with the machining program according to the shape of the workpiece W and outputs the control information to the interface 106. At this time, the drive circuit 107b operates the lift drive 44 based on the control signal input from the interface 106. The head controller 111 also generates control information for causing the chuck 53 to hold or release the tool 20 and outputs the control information to the interface 106. At this time, the drive circuit 107g causes the chuck 53 to be a holding state of the tool 20 or to release the holding state of the tool 20 based on the control signal input from the interface 106. Furthermore, the head controller 111 generates control information for moving the head 5 in the X-axis direction and the Y-axis direction and outputs the control information to the interface 106. At this time, the drive circuits 107c and 107d respectively operate or stop the X-direction drive 71 and the Y-direction drive 76 based on the control signal input from the interface 106.

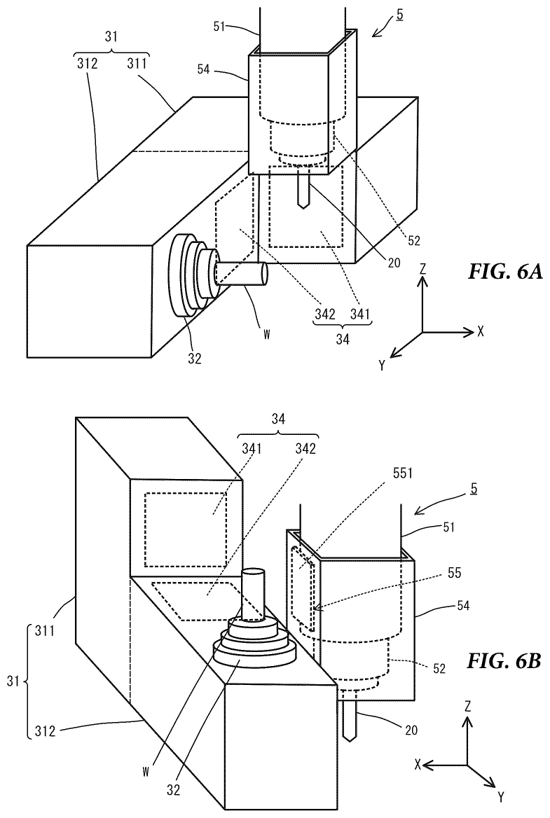

The head controller 111 also generates control information for moving the head 5 so that the sensor part 341 of the proximity sensor 34 provided in the holding unit 3 faces the lateral side of the tool 20 before and after cutting machining of the workpiece W, as illustrated in FIG. 6A, and outputs the control information to the interface 106. Furthermore, after cutting machining of the workpiece W, the head controller 111 generates control information for moving the head 5 so that the proximity sensor 55 provided in the head 5 faces the lateral side of the workpiece W and outputs the control information to the interface 106, as illustrated in FIG. 6B.

Returning to FIG. 5, the holding unit controller 112 generates control information for rotating the entire unit body 31 about the B-axis JB and outputs the control information to the interface 106. At this time, the drive circuit 107e operates or stops the rotary drive 81 based on the control signal input from the interface 106. The holding unit controller 112 also generates control information for rotating the workpiece holder 32 about the C-axis JC and outputs the control information to the interface 106. At this time, the drive circuit 107f operates or stops the rotary drive 86 based on the control signal input from the interface 106.

The signal acquirer 113 obtains detection signal information indicating an intensity of a detection signal that is output from the proximity sensors 34, 55. Here, the signal acquirer 113 obtains detection signal information indicating an intensity of a detection signal that is output from the proximity sensor 34 when the rotary spindle 52 of the head 5 is rotated in a state in which the head 5 is moved so that the sensor part 341 of the proximity sensor 34 faces a lateral side of the tool 20, as illustrated in FIG. 6A, before cutting machining of the workpiece W. The signal acquirer 113 then stores the detection signal information of the proximity sensor 34 obtained for each of the plurality of tools 20 to be used in the cutting machining in the reference signal waveform storage 131 as reference signal waveform information in association with sampling time information indicating sampling time by the proximity sensor 55 and tool identification information of each of the plurality of tools 20, before the cutting machining of the workpiece W. The signal acquirer 113 also obtains detection signal information indicating an intensity of a detection signal that is output from the proximity sensor 34 when the rotary spindle 52 of the head 5 is rotated in a state in which the head 5 holding the tool 20 used in the cutting machining is moved so that the proximity sensor 34 faces the lateral side of the tool after the cutting machining of the workpiece W. Then, the signal acquirer 113 stores the detection signal information of the proximity sensor 34 obtained after the cutting machining of the workpiece W in the signal waveform storage 121 in association with the sampling time information indicating the sampling time by the proximity sensor 55.

Furthermore, after the cutting machining of the workpiece W using the tool 20, the signal acquirer 113 obtains detection signal information indicating an intensity of a detection signal that is output from the proximity sensor 55 when the workpiece holder 32 is rotated in a state in which the head 5 is moved so that the sensor part 551 of the proximity sensor 55 faces a lateral side of the workpiece W, as illustrated in FIG. 6B. Then, the signal acquirer 113 stores the detection signal information of the proximity sensor 55 obtained after the cutting machining of the workpiece W in the signal waveform storage 121 in association with the sampling time information indicating the sampling time by the proximity sensor 55.

The determiner 114 determines whether or not the tool 20 is broken based on the intensity of the detection signal indicated by each of the detection signal information obtained by the proximity sensor 34 before and after the cutting machining of the workpiece W, that is, whether there is a difference in the signal waveforms corresponding to time transitions in the amplitude values of the detection signals. Specifically, the determiner 114 first performs processing for synchronizing the sampling time for the detection signal information constituting the reference signal waveform information stored in the reference signal waveform storage 131 and the sampling time for the detection signal information obtained by the proximity sensor 34 stored in the signal waveform storage 121. Next, the determiner 114 calculates a difference value between the amplitude value indicated by the detection signal information constituting the reference signal waveform information and the amplitude value indicated by the detection signal information stored in the signal waveform storage unit 121 at the same sampling time for all sampling times that are synchronized with each other, and calculates the sum of the calculated difference values as a difference integration value. Then, when the calculated difference integration value is greater than or equal to a preset difference integration threshold, the determiner 114 determines that the tool 20 is broken. In addition, the determiner 114 determines whether there is a broken piece of the tool 20 attached to the workpiece W based on the signal waveform information obtained by the proximity sensor 55 after the cutting machining of the workpiece W. Specifically, the determiner 114 determines that a broken piece of the tool 20 is attached to the workpiece W, for example, when a peak waveform is present in the signal waveform corresponding to the time transition of the amplitude value of the detection signal indicated by each of the detection signal information obtained by the proximity sensor 55 and stored in the signal waveform storage unit 121, and the difference value between the peak value of the peak waveform and the average value of the signal waveform is greater than or equal to a preset difference threshold.

Based on the result of the determination performed by the determiner 114, the notifier 115 generates notification information for notifying an operator of whether or not the tool 20 is broken and whether or not a broken piece of the tool 20 is attached to the workpiece W, and outputs the notification information to the interface 104.

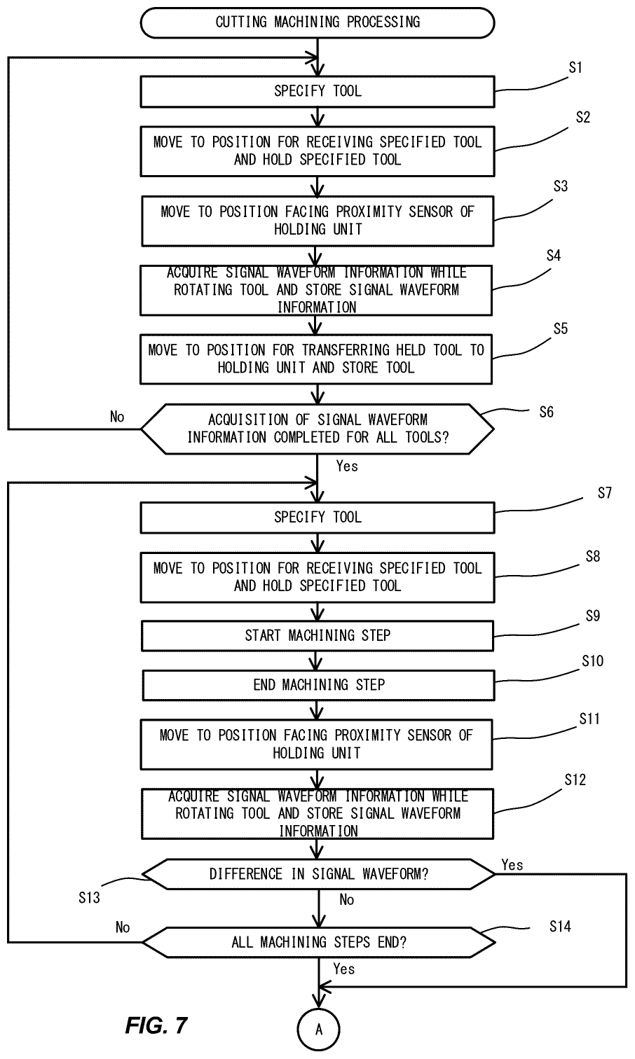

Next, the cutting machining processing performed by the cutting machining apparatus 1 according to the present embodiment is described with reference to FIGS. 7 to 9. Here, the cutting machining apparatus 1 is described as executing at least one machining step on a workpiece W in the cutting machining processing. In addition, in an initial state, the holding unit 3 is assumed to be maintained in a posture in which the tool holder 33 is oriented toward the +Z direction side. Furthermore, in the initial state, the head 5 is assumed to be positioned in the initial position on the +Z direction side of the holding unit 3. First, as illustrated in FIG. 7, when the cutting machining processing is started, the cutting machining apparatus 1 specifies one tool 20 from among at least one tool 20 to be used in the cutting machining (step S1). Next, the cutting machining apparatus 1 moves the head 5 to a position for receiving the specified tool 20 and causing the head 5 to hold the specified tool 20 (step S2). Specifically, the head controller 111 specifies one tool 20 from among the at least one tool 20 to be used in the cutting machining and controls the operation of the X-direction drive 71 and the Y-direction drive 76 so that the head 5 moves from the aforementioned initial position to the +Z direction side of the specified tool 20. In addition, the holding unit controller 112 rotates the holding unit 3 about the B axis JB to control the operation of the rotary drive 81 so that the workpiece W held in the holding unit 3 becomes a posture oriented vertically upward. The head controller 111 then controls the operation of the lift drive 44 to lower the head 5 in the −Z direction to move the head 5 to a position for receiving the specified tool 20. Furthermore, the head controller 111 controls the operation of the chuck 53 so that the chuck 53 holds the specified tool 20 in a state in which the head 5 is arranged at a position for receiving the specified tool.

Subsequently, the cutting machining apparatus 1 moves the head 5 to a position where the tool 20 held by the head 5 faces the proximity sensor 34 of the holding unit 3 (step S3). Specifically, the head controller 111 controls the operation of the X-direction drive 71, the Y-direction drive 76, and the lift drive 44 so that the head 5 is arranged at a position where the sensor part 341 of the proximity sensor 34 provided in the holding unit 3 becomes a state facing a lateral side of the tool 20, as illustrated in FIG. 6A. Returning to FIG. 7, the cutting machining apparatus 1 then obtains signal waveform information that is obtained by the proximity sensor 34 while rotating the tool 20 and stores the signal waveform information in the reference signal waveform storage 131 (step S4). Specifically, the signal acquirer 113 obtains detection signal information indicating an intensity of a detection signal that is output from the proximity sensor 34 while the head controller 111 controlling the operation of the spindle drive 51 so that the rotary spindle 52 holding the tool 20 rotates at a preset rotational speed. Then, the signal acquirer 113 stores the obtained detection signal information in the reference signal waveform storage unit 131 in association with the sampling time information and the tool identification information of the specified tool 20. The head controller 111 stops the rotation of the rotary spindle 52 after rotating the rotary spindle 52 for a preset number of rotations. Next, the cutting machining apparatus 1 moves the head 5 to a position for transferring the tool 20 held in the head 5 to the holding unit 3, and then causes the tool 20 held in the head 5 to be stored in the tool holder 33 of the holding unit 3 (step S5). Specifically, the head controller 111 controls the operation of the X-direction drive 71, the Y-direction drive 76, and the lift drive 44 so that the head 5 is arranged at a position where a portion of the tool 20 held in the head 5 becomes a state disposed inside the tool holder 33 of the holding unit 3. In addition, the holding unit controller 112 rotates the holding unit 3 about the B axis JB to control the operation of the rotary drive 81 so that the workpiece W held in the holding unit 3 becomes a posture oriented vertically upward. The head controller 111 then controls the operation of the chuck 53 to release the holding of the tool 20 by the chuck 53.

Subsequently, the cutting machining apparatus 1 determines whether or not the acquisition of the signal waveform information has been completed for all the tools 20 used in the cutting machining processing (step S6). Here, it is assumed that the cutting machining apparatus 1 determines that, of all the tools 20 used in the cutting machining processing, there is a tool 20 of which signal waveform information has not yet been obtained (step S6: No). In this case, the cutting machining apparatus 1 specifies one of the tools 20 of which signal waveform information has not yet acquired (step S1), and executes a series of processing after step S2 onward again. On the other hand, it is assumed that the cutting machining apparatus 1 determines that the acquisition of the signal waveform information has been completed for all the tools 20 used in the cutting machining processing (step S6: Yes). In this case, the cutting machining apparatus 1 specifies the tool 20 to be used in the first machining step according to the machining program and holds the specified tool 20 (step S7). The cutting machining apparatus 1 then moves the head 5 to a position for receiving the specified tool 20 and then causes the head 5 to hold the specified tool 20 (step S8). Next, the cutting machining apparatus 1 starts one machining step included in the cutting machining processing (step S9). Specifically, in accordance with the content of the machining step, the head controller 111 controls the operation of the spindle drive 51, the X-direction drive 71, the Y-direction drive 76, and the lift drive 44 to move the head 5 so that the tip of the tool 20 contacts the workpiece W while rotating the rotary spindle 52 holding the tool 20. Here, the holding unit controller 112 controls the operation of the rotary drive 81 so that the workpiece holder 32 maintains a posture oriented toward the +Z direction or a direction tilted from the Z axis in accordance with the content of the machining step. Alternatively, the head controller 111 controls the operation of the spindle drive 51, the X-direction drive 71, the Y-direction drive 76, and the lift drive 44 to move the head 5 so that the tip of the tool 20 contacts the workpiece W while maintaining a state in which the rotary spindle 52 holding the tool 20 stops in accordance with the content of the machining step. Here, the holding unit controller 112 controls the operation of the rotary drives 81, 86 so that the workpiece holder 32 maintains a posture oriented toward the +Z direction or a direction tilted from the Z axis while rotating the workpiece holder 32 in accordance with the content of the machining step.

Subsequently, when one machining step ends (step S10), the cutting machining apparatus 1 moves the head 5 to a position where the tool 20 held in the head 5 faces the proximity sensor 34 of the holding unit 3 as illustrated in FIG. 6A (step S11). Returning to FIG. 7, the cutting machining apparatus 1 then obtains the signal waveform information obtained by the proximity sensor 34 while rotating the tool 20 and stores the signal waveform information in the signal waveform storage unit 121 (step S12).

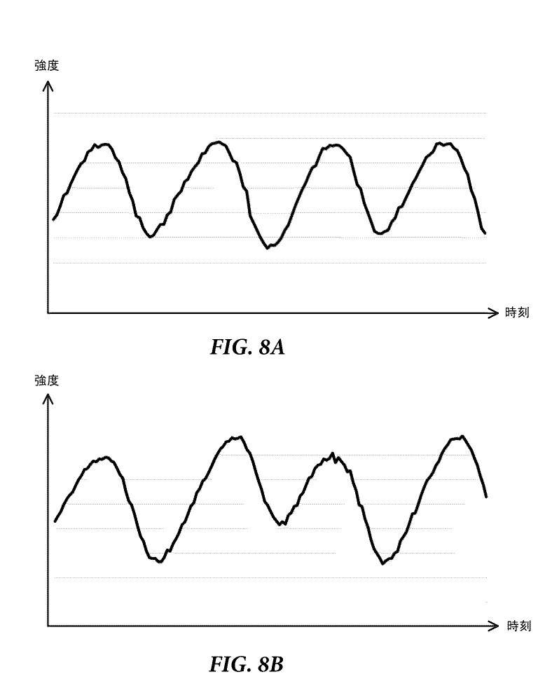

Next, the cutting machining apparatus 1 determines whether or not there is a difference in the signal waveforms indicated by the signal waveform information obtained by the proximity sensor 34 before and after the machining step (step S13). Specifically, the determiner 114 compares a signal waveform corresponding to the time transition of the amplitude value of the detection signal indicated by the detection signal information that is obtained by the proximity sensor 34 and stored in the signal waveform storage 121 and a signal waveform corresponding to the time transition of the amplitude value of the detection signal indicated by the detection signal information that is stored in the reference signal waveform storage 131, and determines whether or not there is a difference in the signal waveforms. Here, the determiner 114 determines that there is a difference in the signal waveforms when the signal waveform corresponding to the reference signal waveform information is, for example, the waveform illustrated in FIG. 8A, and the signal waveform corresponding to the detection signal information stored in the signal waveform storage unit 121 is different from the signal waveform illustrated in FIG. 8A, for example, as illustrated in FIG. 8B. Returning to FIG. 7, when the cutting machining apparatus 1 determines that there is a difference in the signal waveforms (step S13: Yes), the cutting machining apparatus 1 performs the processing of step S15 described later. On the other hand, when the cutting machining apparatus 1 determines that the signal waveforms are the same (step S13: No), the cutting machining apparatus 1 determines whether or not all the machining steps included in the cutting machining processing have ended (step S14). Here, it is assumed that the cutting machining apparatus 1 determines that there is a machining step that has not yet ended among the machining steps included in the cutting machining processing, (step S14: No). In this case, the cutting machining apparatus 1 specifies the tool 20 to be used in the next machining step (step S7) and executes the series of processing from step S8 onwards again.

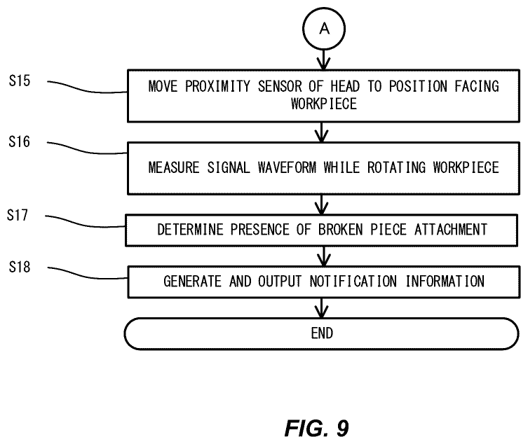

On the other hand, when the cutting machining apparatus 1 determines that all the machining steps included in the cutting machining processing have ended (step S14: Yes), the cutting machining apparatus 1 moves the head 5 to a position where the proximity sensor 55 of the head 5 faces the workpiece W, as illustrated in FIG. 9 (step S15). Specifically, the head controller 111 controls the operation of the X-direction drive 71, the Y-direction drive 76, and the lift drive 44 so that the sensor part 551 of the proximity sensor 55 provided in the head 5 is arranged at a position facing a lateral side of the workpiece W held in the workpiece holder 32 as illustrated in FIG. 6B. Returning to FIG. 9, the cutting machining apparatus 1 then obtains signal waveform information obtained by the proximity sensor 55 while rotating the workpiece W and stores the signal waveform information in the signal waveform storage unit 121 (step S16). Specifically, w % bile the holding unit controller 112 controls the operation of the rotary drive 86 to rotate the workpiece holder 32 that holds the workpiece W, the signal acquirer 113 obtains detection signal information indicating an intensity of a detection signal that is output from the proximity sensor 55, and stores the obtained detection signal information in the signal waveform storage unit 121 in association with sampling time information. Thereafter, the cutting machining apparatus 1 determines whether or not there is a broken piece of the tool 20 attached to the workpiece W based on the signal waveform corresponding to the time transition of the amplitude value of the detection signal indicated by the detection signal information that is obtained by the proximity sensor 55 and stored in the signal waveform storage 121 (step S17). Next, the cutting machining apparatus 1 generates notification information for notifying an operator whether or not the tool 20 is broken and whether or not a broken piece of the tool 20 is attached to the workpiece W, and displays the notification information on the display panel 11 (step S18). Specifically, the notifier 115 generates notification information indicating the result of the determination performed by the determiner 114 and outputs the notification information to the interface 104. Then, the cutting machining processing ends.

As described thus far, with the cutting machining apparatus 1 according to the present embodiment, the signal acquirer 113 obtains detection signal information indicating an intensity of a detection signal that is output from the proximity sensor 34 when the rotary spindle 52 is rotated in a state in which the head 5 is moved so that the proximity sensor 34 is disposed on a lateral side of the tool 20 before and after the cutting machining of the workpiece W. Then, the determiner 114 determines whether or not the tool 20 is broken based on whether or not there is a difference in the signal waveforms corresponding to the time transitions in the intensities of the detection signals indicated by the detection signal information obtained before and after the cutting machining. This makes it possible to quickly detect a breakage of the tip of the tool 20 during cutting machining of the workpiece W, thereby improving the machining accuracy of the workpiece W.

Incidentally, when the dimensions of a workpiece W become smaller, the dimensions of the tool 20 used for machining the workpiece W also become smaller accordingly. In a case where the workpiece W is subjected to micro-cutting machining, even a micro crack occurring in the tool 20 greatly affects the machining accuracy. However, a micro crack in the tool 20 may not be visible to an operator. To address such a problem, the cutting machining apparatus 1 according to the present embodiment utilizes a correlation between the waveform of the detection signal that is output from the proximity sensor 34 and the shape of the tool 20 to detect the presence of a breakage in the tool 20 during cutting machining by obtaining detection signal information indicating the amplitude of a detection signal that is output from the proximity sensor 34 while rotating the rotary spindle 52 holding the tool 20 before and after cutting machining of the workpiece W and comparing the signal waveforms corresponding to the time transitions of the amplitudes of the detection signals indicated by the obtained detection signal information. This makes it possible to detect a micro crack in the tool 20 that is difficult for an operator to visually check.

In addition, the proximity sensor 34 according to the present embodiment is disposed inside the unit body 31 of the holding unit 3, and the proximity sensor 55 is disposed inside the head cover 54. In this way, the proximity sensors 34, 55 are arranged in a state isolated from the machining area S1, so that the cleanliness of the machining area S1 can be maintained. In addition, cleaning, sterilization, or other processing of the proximity sensors 34, 55 are not necessary for each cutting machining of the workpiece W, providing an advantage in that the workload of the operator performing cutting machining of the workpiece W is reduced.

Furthermore, the signal acquirer 113 according to the present embodiment obtains signal waveform information indicating the waveform of a detection signal that is output from the proximity sensor 55 when the workpiece holder 32 is rotated in a state in which the head 5 is moved so that the proximity sensor 55 faces a lateral side of the workpiece W after cutting machining of the workpiece W. Then, the determiner 114 determines whether or not there is a broken piece of the tool 20 attached to the workpiece W based on the signal waveform information obtained from the proximity sensor 55. This makes it possible to detect attachment of a broken piece to the workpiece W that is generated when the tool 20 broke. Accordingly, for example, a workpiece W having a machining defect due to a breakage of the tool 20 can be prevented from flowing out to a post-process after the process of the cutting machining processing.

In addition, in the cutting machining apparatus 1 according to the present embodiment, the workpiece holder 32, the tool holder 33, and the chuck 53 are disposed inside the interior case 13, the first cover 141 occludes between the head 5 and the outer periphery of the opening 13a in the interior case 13, and the second cover 142 occludes between the holding unit 3 and the outer periphery of the opening 13b in the interior case 13. The tool holder 33 is also secured to the unit body 31 in such a way that, in a state in which the tool 20 is not inserted in the tool holder 33, the inside of the tool holder 33 is in communication with the outside of the unit body 31 of the holding unit 3 and the outer wall of the tool holder 33 is isolated from the outside of the unit body 31. As a result, the machining area S1 where cutting machining is conducted and that is isolated from the outside of the interior case 13 can be formed inside the interior case 13, thereby suppressing foreign matters present outside the interior case 13 from entering into the machining area S1.

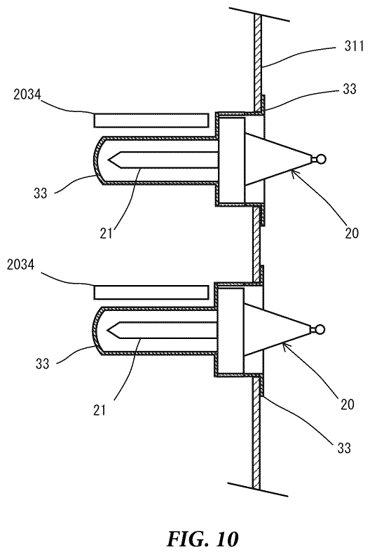

Although an embodiment of the present disclosure has been described above, the present disclosure is not limited to the configuration of the aforementioned embodiment. For example, as illustrated in FIG. 10, the holding unit may have a proximity sensor 2034 disposed in the vicinity of a portion where the blade 21 of the tool 20 is stored in the tool holder 33. In this case, the controller may include: a type specifier that specifies the type of the blade 21 of the tool 20 based on a detection signal output from the proximity sensor 2034 in a state in which the tool 20 is held in the tool holder 33; and a type determiner that determines whether or not the type of the tool 20 specified by the type specifier and the type of the tool 20 that is set in advance to be held by each tool holder 33.

According to this configuration, the occurrence of a setting error of the tool 20 in the tool holder 33 can be suppressed.

In an embodiment, the cutting machining apparatus 1 may move the head 5 to a position where the workpiece W faces the proximity sensor 55 of the head 5 just prior to starting the machining step to obtain signal waveform information while rotating the workpiece W and specify the shape of the workpiece W held in the workpiece holder 32 based on the obtained signal waveform information. The cutting machining apparatus 1 may then specify the type of the tool 20 to be used in the machining step based on the shape of the specified workpiece W.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure is suitable as a cutting machining apparatus for cutting machining of bones.

1. A cutting machining apparatus comprising:
a head including a spindle drive that rotary drives a rotary spindle with a tool secured to a tip of the rotary spindle;
a first proximity sensor;
a signal acquirer obtaining detection signal information indicating an intensity of a detection signal that is output from the first proximity sensor when the rotary spindle is rotated in a state in which the head is moved so that the first proximity sensor faces a lateral side of the tool before and after cutting machining of a workpiece using the tool; and
a determiner determining whether or not the tool is broken based on whether or not there is a difference in signal waveforms corresponding to time transitions in intensities of the detection signals indicated by the detection signal information obtained before and after the cutting machining.

2. The cutting machining apparatus according to claim 1, further comprising:
a holding unit including:
a workpiece holder that holds the workpiece; and
a unit body that supports the workpiece holder in a state in which the workpiece holder is exposed outside,
wherein the first proximity sensor is disposed inside the unit body.

3. The cutting machining apparatus according to claim 1, further comprising:
a holding unit including:
a workpiece holder that holds the workpiece; and
a rotary drive that rotary drives the workpiece holder holding the workpiece; and
a second proximity sensor disposed in the head, wherein
the signal acquirer obtains a signal waveform of a detection signal that is output from the second proximity sensor when the workpiece holder is rotated in a state in which the head is moved so that the second proximity sensor faces a lateral side of the workpiece after cutting machining of the workpiece using the tool, and
the determiner determines whether there is a broken piece of the tool attached to the workpiece based on the signal waveform obtained from the second proximity sensor after the cutting machining.

4. The cutting machining apparatus according to claim 3, wherein
the head of a bottomed tubular shape comprises a bottom wall with an opening through which the rotary spindle is inserted and further comprises a head cover in which the spindle drive is disposed, and
the second proximity sensor is disposed inside the head cover.

5. The cutting machining apparatus according to claim 2, further comprising:
an interior case including, in a peripheral wall, a first opening through which the head is inserted and a second opening through which the holding unit is inserted, and housing the workpiece holder and the tool disposed inside;
a first cover formed of a soft material and occluding between the head and an outer periphery of the first opening in the interior case; and
a second cover formed of a soft material and occluding between the holding unit and an outer periphery of the second opening in the interior case.

6. The cutting machining apparatus according to claim 4, further comprising:
an interior case including, in a peripheral wall, a first opening through which the head is inserted and a second opening through which the holding unit is inserted and housing the workpiece holder and the tool disposed inside;
a first cover formed of a soft material and occluding between the head and an outer periphery of the first opening in the interior case; and
a second cover formed of a soft material and occluding between the holding unit and an outer periphery of the second opening in the interior case.

7. The cutting machining apparatus according to claim 2, further comprising:
a holding unit including:
a workpiece holder that holds the workpiece; and
a rotary drive that rotary drives the workpiece holder holding the workpiece; and
a second proximity sensor disposed in the head, wherein
the signal acquirer obtains a signal waveform of a detection signal that is output from the second proximity sensor when the workpiece holder is rotated in a state in which the head is moved so that the second proximity sensor faces a lateral side of the workpiece after cutting machining of the workpiece using the tool, and
the determiner determines whether there is a broken piece of the tool attached to the workpiece based on the signal waveform obtained from the second proximity sensor after the cutting machining.

8. The cutting machining apparatus according to claim 7, wherein
the head of a bottomed tubular shape comprises a bottom wall with an opening through which the rotary spindle is inserted and further comprises a head cover in which the spindle drive is disposed, and
the second proximity sensor is disposed inside the head cover.
